(19) United States
(12) Patent Application Publication
(10) Pub. No.: US 2015/0235492 A1
(43) Pub. Date: Aug. 20, 2015

(54) Triple Password Proximity-Interrogative Smart Fob Switching Of Electrical Device

(71) Applicant: Double Secured, Inc., Santa Fe Springs, CA (US)

(72) Inventors: Sukki Hong, Irvine, CA (US); Yong Moo Lee, Seoul, CA (US)

(73) Assignee: Double Secured, Inc., Santa Fe Springs, CA (US)

(21) Appl. No.: 14/181,005

(22) Filed: Feb. 14, 2014

(51) Int. Cl. G07C 9/00

(52) U.S. Cl. CPC G07C 9/00111

(57) ABSTRACT

A smart module for actuating an electrical device in response to a smart fob includes: a low frequency transmitter for transmitting a first password and a smart module ID number in a low frequency signal; an auto-polling timer controlling a length of time between transmissions of the first password and the smart module ID number over a predetermined time frame; a high frequency receiver for receiving a high frequency signal including a second password; a memory for storing a registration number with which the smart fob is registered to the smart module, a smart module ID number for the smart module and a third password; a sending unit connected to the electrical device; and a processor for decrypting the second password and determining if the second password is from the smart fob registered to the smart module and then sending the third password to the electrical device via the sending unit if the second password is from the smart fob registered to the smart module.

### BACKGROUND OF THE INVENTION

1. Field of the Invention

Embodiments of the invention relate to activating an electrical device, and more particularly, to activating an electrical device in the proximity of a fob. Although embodiments of the invention are suitable for a wide scope of applications, it is particularly suitable for sending a predetermined activation signal or set password to the electrical device only when a specific fob is in proximity.

2. Discussion of the Related Art

In general, a proximity switching system has a receiving device and a fob that can transmit a wireless signal. A fob has to be sufficiently close to the receiving device such that a wireless signal transmitted from the fob can be received by the receiving device. The range within which the receiving device can receive wireless signals of the fob is the proximity. Accordingly, an increase in the signal strength of the fob or an increase in reception capability of the receiving device will increase proximity. On the other hand, a decrease in the signal strength of the fob or a decrease in reception capability of the receiving device will decrease proximity.

There are two types of wireless fobs: an active fob and a reactive fob. An active fob transmits an activation code as result of a user pushing a button on the active fob. If the active fob is in proximity while the button is pushed, then the receiving device receives the activation code from the active fob and actuates an electrical device. A reactive fob transmits an activation code in response to a predetermined wireless wake-up ping from a receiving device. Typically, the reactive fob is inherently in proximity when receiving a wireless wake-up ping from a receiving device because the strength of the wireless wake-up is less than the signal transmission strength of the reactive fob. Upon receiving the wireless wake-up ping from the receiving device, the reactive fob transmits a predetermined activation code and then the receiving device receives the predetermined activation code from the reactive fob and actuates an electrical device.

In the cases of both the active fob and the reactive fob, the transmitted predetermined activation code is a set code transmitted from the fob out into the open everytime. Thus, the transmitted predetermined activation code can be captured or recorded during a wireless signal transmission from the fob. In other words, the transmitted predetermine activation code can be stolen and subsequently used inappropriately to activate the electrical device. Today, there are numerous types of security devices designed to receive a set code transmitted in the open. Other than limiting transmissions of the set code to very short ranges or very near proximity, there is no other way to protect a set code transmitted in the open from a very sensitive snooping antenna.

### SUMMARY OF THE INVENTION

Accordingly, embodiments of the invention are directed to proximity-interrogative fob that substantially obviates one or more of the problems due to limitations and disadvantages of the related art.

An object of embodiments of the invention is to provide a proximity-interrogative fob that is reactive to a specified receiving device associated with an electrical device.

Another object of embodiments of the invention is to provide of a proximity-interrogative fob that can provide a desired coded signal to the receiving device based upon a coded signal from the receiving device.

Another object of embodiments of the invention is to provide of a proximity-interrogative fob that receives a low frequency signal from the receiving device and either automatically transmits a high frequency signal to the receiving device or can be triggered to transmit a high frequency signal to the receiving device.

Another object of embodiments of the invention is to provide of a proximity-interrogative fob that is registered to the receiving device and is capable of transmitting a high frequency coded signal to the receiving device based on the registration number of the fob and a low frequency coded signal from the receiving device.

Another object of embodiments of the invention is for the receiving device to send a set password a very short distance to an electrical device in response to a high frequency coded signal from a fob based on a registration number of the fob and a low frequency coded signal from the receiving device.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a smart module for activating an electrical device in response to a smart fob includes: a low frequency transmitter for transmitting a first password and a smart module ID number in a low frequency signal; an auto-polling timer controlling the length of time between transmissions of the first password and the smart module ID number over a predetermined time frame; a high frequency receiver for receiving a high frequency signal including a second password; a memory for storing a registration number with which the smart fob is registered to the smart module, a smart module ID number for the smart module and a third password; a sending unit for providing the third password to the electrical device; and a processor for decrypting the second password and determining if the second password is from a smart fob registered to the smart module and then sending a third password to the electrical device via the sending unit if the second password is from a smart fob registered to the smart module.

In another aspect, a system for actuating an electrical device, includes: a low frequency transmitter in a smart module for transmitting a first password and a smart module ID number in a low frequency signal; a low frequency receiver in a smart fob for receiving a first password and a smart module ID number in the low frequency signal; a first processor in the smart fob for providing a second password derived from the first password and a registration number with which the smart fob is registered to the smart module; a high frequency transmitter in the smart fob for transmitting a high frequency signal including the second password; a high frequency receiver in the smart module for receiving a high frequency signal including the second password; a second processor in the smart module for decrypting the second password to determine if the second password is from a smart fob registered to the smart module and then enabling a third password to be sent to an electrical device if the second password is from a smart fob registered to the smart module.

In another aspect, a system for actuating an electrical device includes: a low frequency transmitter in the smart module for transmitting a first password and a smart module ID number in a low frequency signal; a low frequency receiver in the smart fob for receiving a first password and a smart module ID number in the low frequency signal; a first processor in the smart fob for providing a second password derived from the first password and a registration number with which the smart fob is registered to the smart module; a high frequency transmitter in the smart fob for transmitting a high frequency signal including the second password; a high frequency receiver in the smart module for receiving a high frequency signal including the second password; a second processor in the smart module for decrypting the second password to determine if the second password is from a smart fob registered to the smart module and then sending a third password via the high frequency transmitter of the smart module to the electrical device if the second password is from a smart fob registered to the smart module.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is an illustration of a door with a door lock responsive to a smart module in a wall adjacent to the door and a fob according to an embodiment of the invention.

FIG. 2 is an illustration of a door with a key pad coded door lock responsive to a smart module in a wall adjacent to the door and a fob according to an embodiment of the invention.

FIG. 3 is an illustration of a door with a finger pad coded door lock responsive to a smart module in a wall adjacent to the door and a fob according to an embodiment of the invention.

FIG. 4 is a flow diagram of a smart module in a device interacting with smart fob to transmit an encoded signal to a receiving device according to an embodiment of the invention.

FIG. 5 is a block diagram of a smart module that transmits an encoded signal to a receiving device according to an embodiment of the invention.

FIG. 6 is a block diagram of a smart fob according to an embodiment of the invention.

FIG. 7 is a block diagram of a receiving device according to an embodiment of the invention.

### DETAILED DESCRIPTION OF THE PREFERRED EMBODIMENTS

Reference will now be made in detail to the preferred embodiments of the invention, examples of which are illustrated in the accompanying drawings. Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

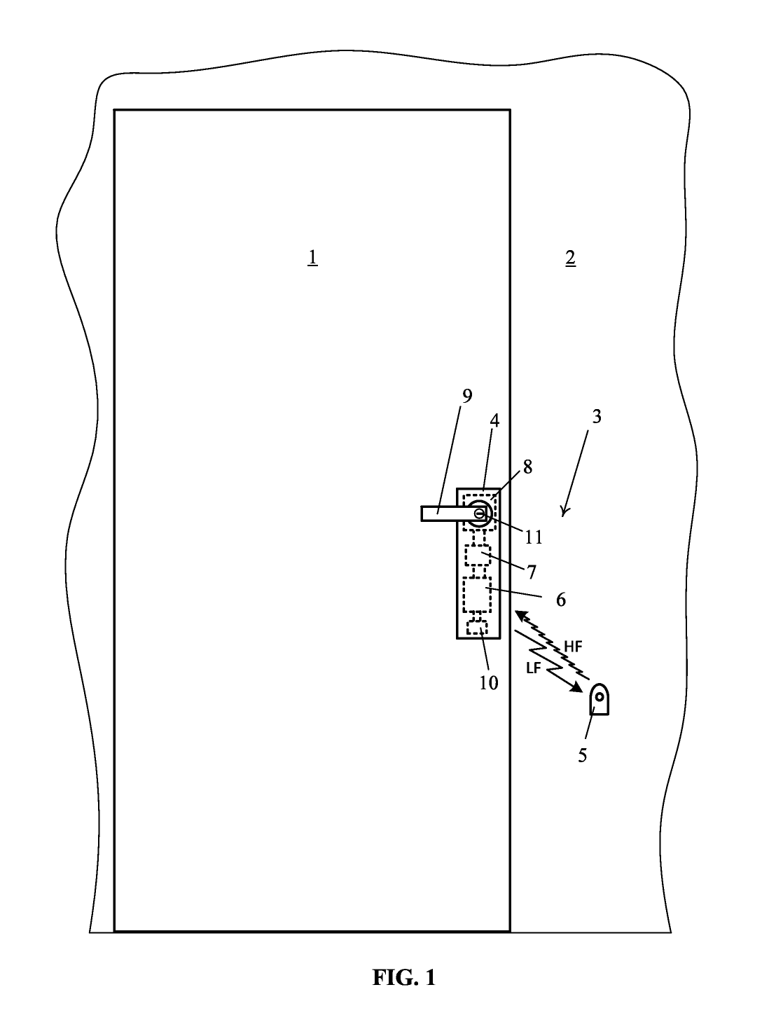

FIG. 1 is an illustration of a door with a door lock responsive to a smart module in a wall adjacent to the door and a fob according to an embodiment of the invention. As shown in FIG. 1, a door 1 in wall 2 is secured by a locking system 3 having a locking device 4, a smart module 5 and a smart fob 6. The smart module 5 is in the wall 2 immediately adjacent to the door 1. The locking device 4 includes a receiver 16 connected to a relay 17 that can enable a door handle 18 to open the door 1 when an appropriate predetermined activation signal is received by the receiver 16 via a low power RF transmission from the smart module 5. The smart module 5 is connected to a buzzer 7 indicating that the appropriate predetermined activation signal is being sent to the receiver 16.

When the smart fob 6 is in proximity to the smart module 5, the smart fob 6 receives a first password via a low frequency LF signal from the smart module 5 and responds with the transmission of a second password based on the first password via a high frequency HF signal to the smart module 5. If the smart module 5 determines that the appropriate second password has been received in response to its transmission of the first password, the smart module 5 sends a third password, which is the predetermined activation signal for the receiver 16, by a radio frequency RF such that the handle 18 can be turned to open the door 1. When the smart fob 6 is no longer in proximity to the smart module 5, the smart module 5 no longer transmits the third password such that the door handle 18 will no longer open the door 1.

The smart module 5 in the wall 1 can be powered by an external power source while the locking device 4 and the smart fob 6 are respectively powered by batteries. The reactive smart fob 6, which only responds to a first password when a button is pushed, will use less power since the smart fob 6 does not have its receiver turned on looking for the first password. A mechanical lock 19 operated by a key can be used to open the door 1 with the handle 18 to override the locking system 3, such as in the event of a battery failure in the locking device 4 or a power failure for the smart module 5. Although the door 1 is shown in FIG. 1, the locking system 3 can also be used on a safe, drawer, gate or other closure mechanisms at which restricted access is desired. Further, another fob that transmits the third password can be used with the receiver 16 that bypasses the use of the smart module 5

Proximity for the smart fob 6 to the smart module 5 for the locking device 4 is dependent upon three aspects. First, the smart fob 6 must be able to receive a low frequency LF signal containing the first password from the smart module 5. Second, the smart fob 6 must be registered to the smart module 5. Third, the smart module 5 must be able to receive a high frequency HF signal containing the second password from the smart fob 6. Thus, proximity for the smart fob 6 to the smart module 5 is controlled by how far the smart module 5 can transmit a low frequency LF signal containing the first password, whether the smart fob 6 is registered to the smart module 5, and how far the smart fob 6 can transmit a high frequency HF signal containing the second password. If the smart fob 6 receives the low frequency LF signal containing the first password out of the range of the smart fob 6 to transmit the high frequency HF signal containing the second password to the smart module 5, then the smart fob 6 will waste power transmitting a nonreceivable high frequency HF signal. Thus, the smart module 5 should transmit a low frequency LF signal containing the first password at a power level such that distance within which the smart fob 6 receives the low frequency LF signal containing the first password is within the range of the smart fob 6 to transmit the high frequency HF signal containing the second password to the smart module 5.

Positioning the smart module 5 close to the receiver 16 and transmitting the third password at very low power, greatly reduces the likelihood of the third password being copied. The third password can be programmed into the smart module 5. Thus, the smart fob 6 and the smart module 5 can replace a previous fob that was programmed to transmit the third password. Such a replacement of a previous fob, either active or reactive, that was openly transmitting the third password, which is the predetermined activation signal for the receiver 16, decreases the vulnerability of the third password being copied. Because the second password is based on the first password and the first password constantly changes, copying the first and second passwords is inconsequential to being able to open the locking device 4.

An exemplary present system that can be retrofitted with an embodiment of the invention is a garage door opening system. A smart module can be programmed to transmit the predetermined activation code at very low power and positioned adjacent to the receiver of the garage door opener. A reactive smart fob is then used with the smart module. Although the old garage door remote will still work, it is no longer used to prevent illicit copying of the predetermined activation code for the garage door opener.

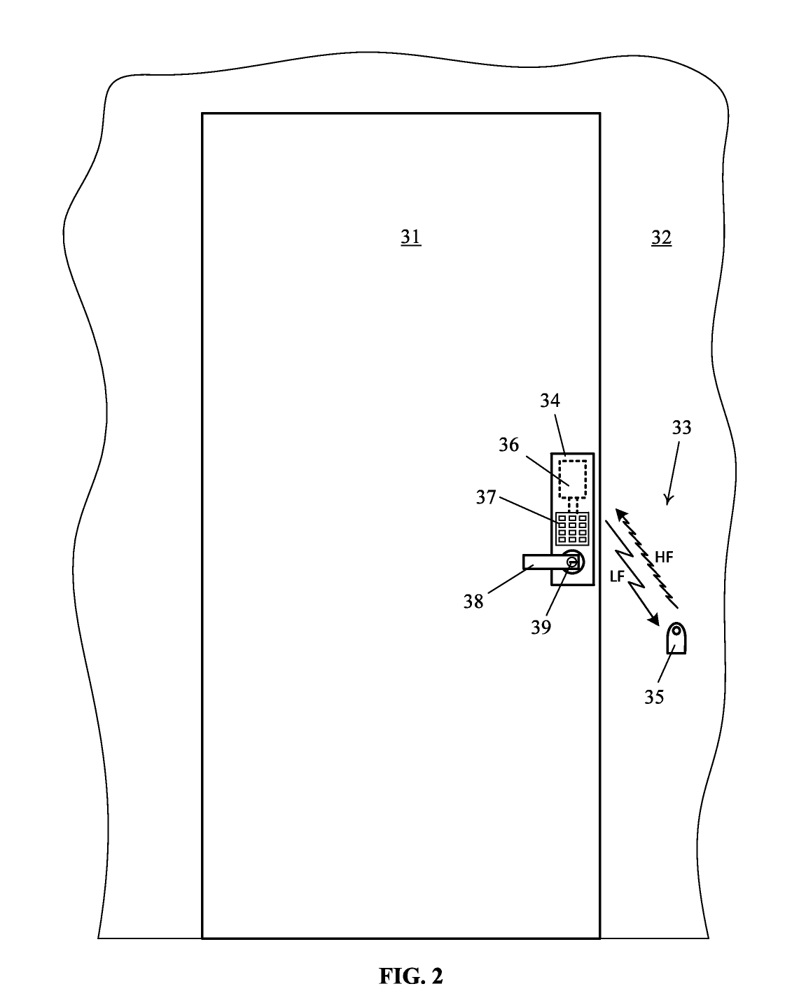

FIG. 2 is an illustration of a door with a key pad coded door lock responsive to a smart module in a wall adjacent to the door and a fob according to an embodiment of the invention. As shown in FIG. 2, a door 21 in wall 22 is secured by a locking system 23 having a locking device 24, a smart module 25 and a smart fob 26. The smart module 25 is in the wall 22 immediately adjacent to the door 21. The locking device 24 includes a receiver 27 connected to the additional security feature of a key pad 28 that can enable a door handle 29 to open the door 21 when an appropriate key code is punched into the keypad 28. This additional security feature prevents a stolen smart fob enabling entry. A mechanical lock 30 turned with a key can be used to open the door 21 with the handle 29 to override the locking system 23. Although a door 1 is shown in FIG. 2, the locking device 24 can also be used on a safe, drawer, gate or other closure mechanisms at which restricted access is desired.

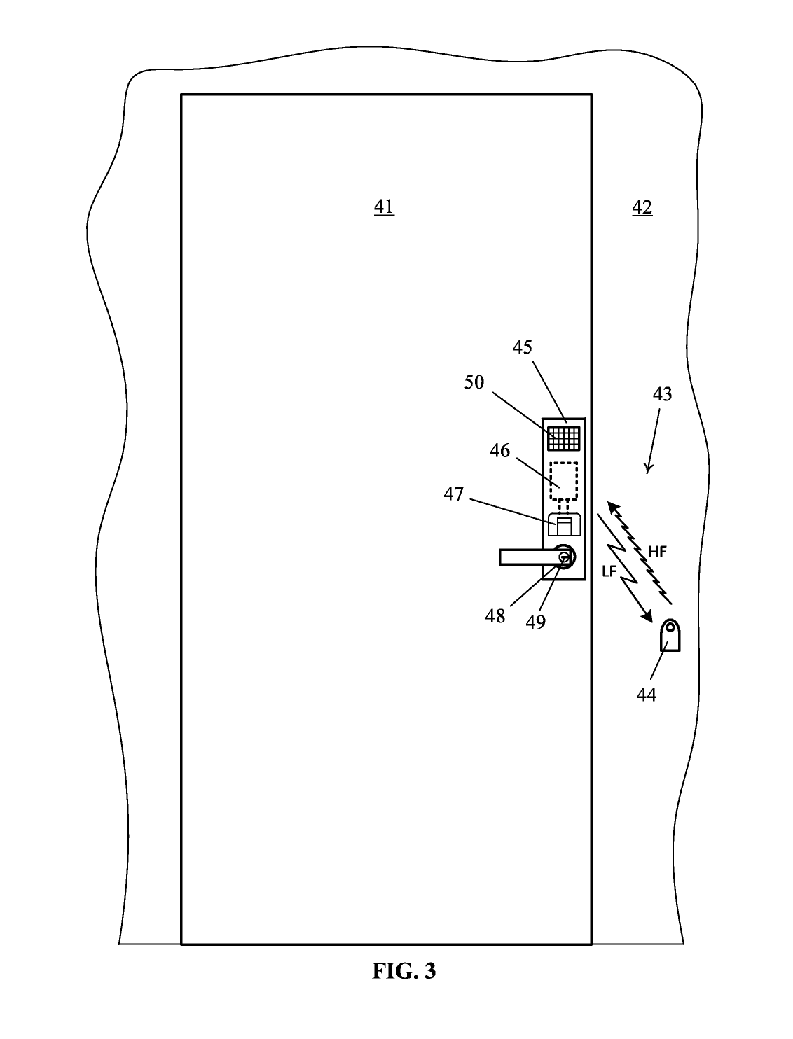

FIG. 3 is an illustration of a door with a finger pad coded door lock responsive to a smart module in a wall adjacent to the door and a fob according to an embodiment of the invention. As shown in FIG. 3, a door 31 in wall 32 is secured by a locking system 33 having a locking device 34, a smart module 35 and a smart fob 36. The smart module 35 is in the wall 32 immediately adjacent to the door 31. The locking device 34 includes a receiver 37 connected to the additional security feature of a key pad 38 that can enable a door handle 39 to open the door 31 when an appropriate key code is punched into the keypad 38. This additional security feature prevents a stolen smart fob enabling entry. A mechanical lock 40 turned with a key can be used to open the door 31 with the handle 39 to override the locking system 33. Although a door 31 is shown in FIG. 3, the locking device 34 can also be used on a safe, drawer, gate or other closure mechanisms at which restricted access is desired.

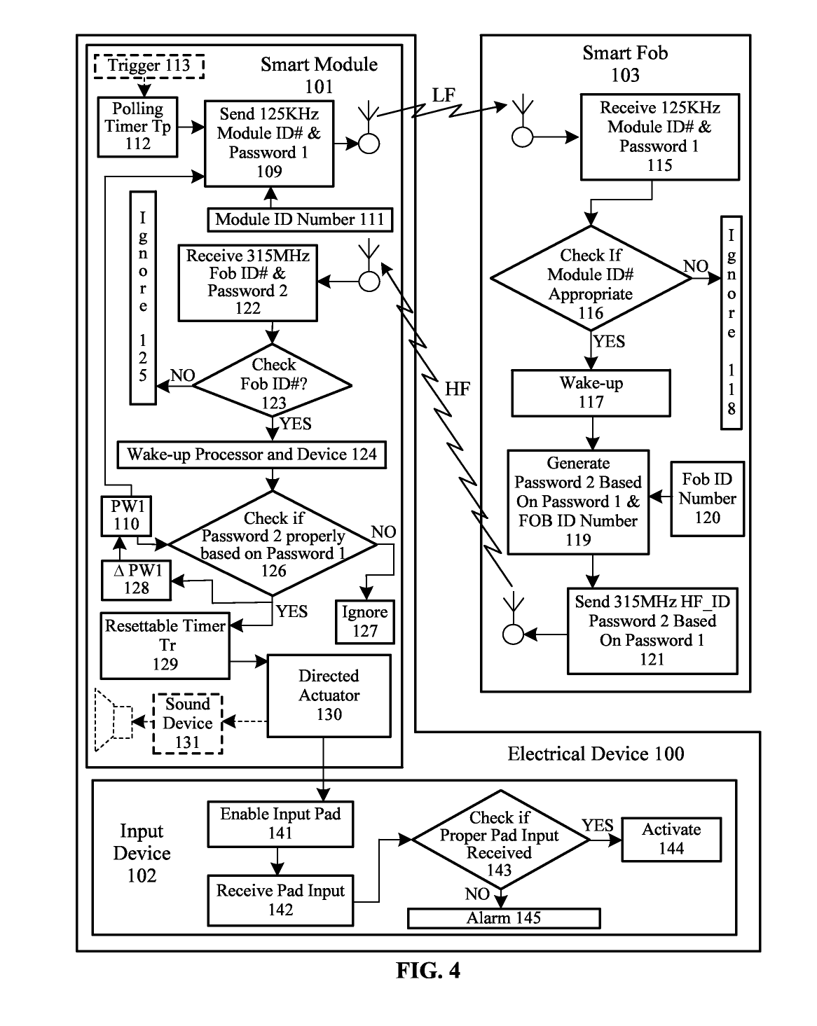

FIG. 4 is a flow diagram of a smart module in a device interacting with a smart fob to transmit an encoded signal to a receiving device according to an embodiment of the invention. As shown in FIG. 4, a system 100 for activating a locking device 101 includes a smart module 102 associated with the locking device 101 and a smart fob 103. The activation process starts with the smart module 102 sending 109 a first password 110 and a module ID#111 by a low frequency wireless transmission, such as 125 KHz, to the smart fob 103. The first password 110 is randomly chosen and can be 16-bit, 24-bit or 32-bit. The module ID#111 is a unique number for the smart module 102, like a serial number for that smart module 102. The module ID#111 can be 16-bit, 24-bit or 32-bit.

The sending 109 of the first password and the module ID# can be initiated by an auto-polling timer 112 that is constantly on or, in the alternative, a trigger 113 turns-on the auto-polling timer for a period of time in response to a triggering event, such as motion sensor and/or a manual triggering by the pressing of a button. The period of time that the auto-polling timer 112 is triggered on can be the duration of the triggering event or a set time period (i.e. a timed triggering) in response to the trigger event. The auto-polling timer 112 that is constantly on controls the length of time Tp between the low frequency LF wireless transmissions. The auto-polling timer 112 that is triggered 113 also controls the length of time Tp between the low frequency LF wireless transmissions. Triggering of the auto-polling timer 112 for sending 110 the first password PW1 and the module ID# saves power compared to the auto-polling timer 112 that is constantly on.

The smart fob 103 receives 115 the low frequency LF wireless transmission containing the first password and the module ID#, as shown in FIG. 4. The receiving 115 can be automatically or, alternatively, manually triggered 116. Then, the smart fob 103 checks 117 to see if the module ID# is the module ID# of the smart module 102 to which the smart fob 103 is registered. The smart fob 103 has a memory containing one or module ID#'s to which the smart fob 103 is registered. If the module ID# is to the smart module 102 to which the smart fob 103 is registered, then the smart fob 103 wakes-up 118. If the module ID# is to a smart module 102 to which the smart fob 103 does not recognize, then the smart fob 103 ignores 119 the low frequency LF wireless transmission containing the first password and the module ID#.

Prior to the smart fob wake-up 118, as shown in FIG. 4, the smart fob 103 is minimally powered such that only the receiving 115 and checking capability 117 of the smart fob 103 is powered up. Such a minimal power configuration conserves the battery of the smart fob 103 while maintaining the receiving 115 and checking capability 117. The smart fob 103 is only woke-up to be responsive to the smart module 102 to which the smart fob 103 is registered. The smart fob 103 ignores 119 a transmission from a smart module 102 having the module ID# not in the memory of the smart fob 103. Alternatively, as mentioned previously, both the receiving 115 and checking capability 117 can only be powered on a manual trigger, and then woke up in response to a smart module 102 to which the smart fob 103 is registered.

After the smart fob 103 is woke-up 118, a second password PW2 is generated 120 based on the first password received and the fob registration number 121. In effect, the fob registration number 121 is like a private key used to encrypt the first password into a second password. Later in the smart module 102, the second password is decrypted using the first password to see if the registration number 121 results. Alternatively, private key like encryption methods can be used. For example, the second password is decrypted with the fob registration number, which is associated with a fob ID#, to see if the first password results.

As shown in FIG. 4, the second password PW2 and the fob ID#122 are sent 123 to the smart module 102 by a high frequency HF wireless transmission, such as 315 MHz. The fob ID#122 is a unique number for the smart fob 103, like a serial number for that smart fob 103. The fob ID#122 can be 16-bit, 24-bit or 32-bit.

The sending 123 and generating 120 processes take the most power in the smart fob 103. By checking 117 to see if the module ID# is for a smart module 102 to which the smart fob 103 is registered, battery power is conserved. The smart fob 103 can be awoken and send a second password PW2 upon receipt of the first transmission of the first password PW1 or, alternatively, awake on the first password transmission PW1 and then send the second password PW2 upon receipt of the second transmission of the first password PW1.

As shown in FIG. 4, the smart module 102 receives 124 the high frequency HF wireless transmission containing the second password PW2 and the fob ID#. The smart module 102 has a memory containing fob ID#'s registered to the smart module 102 as well as the fob registration numbers associated with the fob ID#'s. After receiving 124 the second password PW2 and the fob ID#, the second password PW2 is then checked 126 to see if the first password 110 was properly encrypted based on the fob registration number of the smart fob having that particular fob ID#. If the second password PW2 is not properly encrypted based on the fob registration number for the fob ID#, then the smart module 102 ignores 127 the high frequency HF wireless transmission containing the second password PW2 and the fob ID#. If the second password PW2 is properly encrypted based on the fob registration number for a fob ID# of a smart fob 103 registered to the smart module 102, then the smart module 102 changes 128 the first password 110 for the next low frequency LF wireless transmission and pulses a resettable timer 129 to start a timer that enables transmission 130 of the third password PW3 from the PW3 memory 131 by a radio frequency RF to the locking device 101. Alternatively, a sound device 132 can emit a sound as the third password PW3 of the PW3 memory 131 is transmitted by radio frequency RF.

The resettable timer 129 runs for a period of time Tr upon receiving a pulse due to the check of a second password being determined as properly encrypted based on the fob registration number for the fob ID#122 of the smart fob 103 registered to the smart module 102. The resettable timer 129 resets upon receipt each of subsequent pulse resulting from the check 126 that the first password 110 was properly encrypted based on the fob registration number of the smart fob 103 registered to the smart module 102. To keep the resettable timer 129 continuously running by constantly restarting the resettable timer 129 while the smart fob 103 is in proximity to the smart module 102, the length of time Tp between the low frequency LF wireless transmissions controlled by the auto-polling timer 112 should be less than the period of time Tr for the resettable timer 129. For example, the length of time Tp for the auto-polling timer 112 is one second while the period of time Tr for the resettable timer 129 is three seconds.

As shown in FIG. 4, the resettable timer 129 enables transmission 130 of the third password PW3 from the by a radio frequency RF to the locking device 101 while the resettable timer 129 is running. The locking device 101 receives 132 the third password PW3 of the PW# memory 131 via the radio frequency RF. The third password PW3 is then checked 134 to see if the third password PW3 from the PW3 memory 131 of the smart module 102 is correct. If the third password PW3 is not proper, then the locking device 102 ignores 135 the radio frequency RF wireless transmission containing the third password PW3. If the third password PW3 is proper, then the locking device 101 is actuated 136, which can be locking the device or unlocking the device depending on the application. In the alternative, an input pad 138 can be actuated for receiving an input, which is checked 139 to determine if the input is ignored 140 or unlocks 141 the locking device 101.

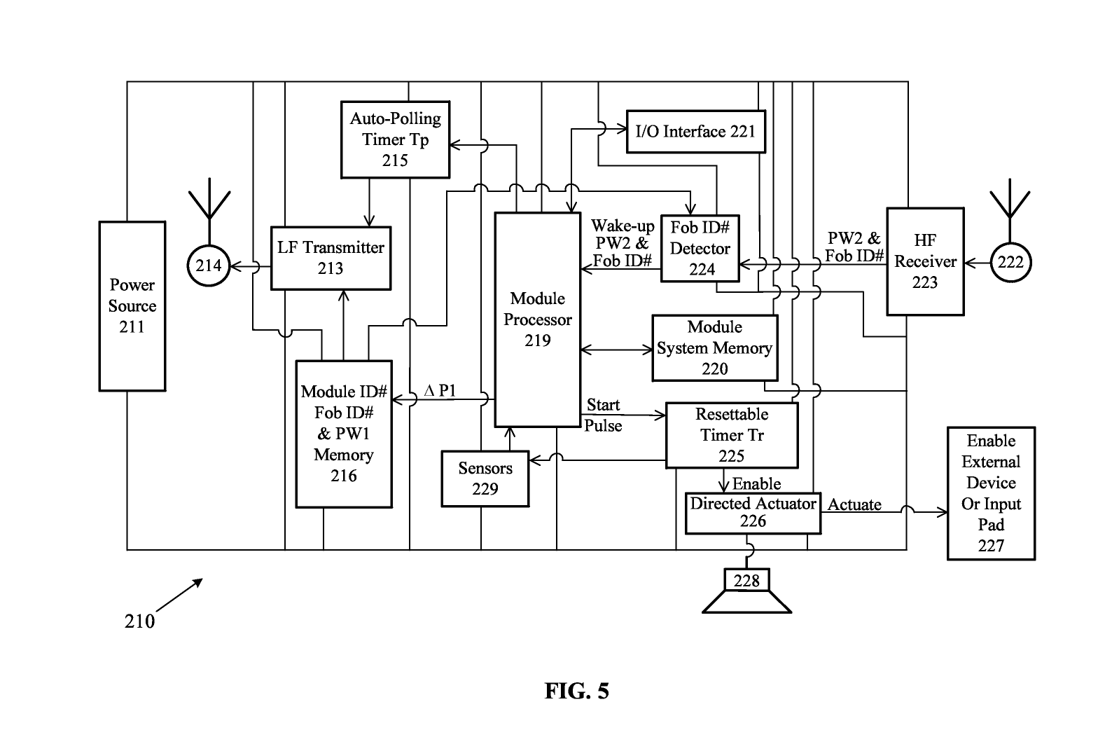

FIG. 5 is a block diagram of a smart module that transmits an encoded signal to a receiving device according to an embodiment of the invention. As shown in FIG. 5, a smart module 210 includes a power source 211 that provides power to the components of the smart module 210. The power source 211 can be a battery, solar-assisted battery or external DC power supply.

Amongst other components, the smart module 210 in FIG. 5 includes a low frequency transmitter 215 connected to a low frequency antenna 213. A module ID# and a first password memory 219 provides the first password and the module ID# to the low frequency transmitter 215. An auto-polling timer 216 is connected to the low frequency transmitter 215 to control the length of time Tp between low frequency LF wireless transmissions, including the first password and the module ID#.

A module processor 217 is connected to the module ID# and the first password memory 219, as shown in FIG. 5. The module processor 217 changes the first password in the module ID# and the first password memory 219 after a use or attempted use of a previously transmitted first password. The module processor 217 randomly selects the next first password.

The module processor 217 in FIG. 5 is connected to the auto-polling timer 216. The module processor 217 can be used to set the length of time Tp between low frequency LF wireless transmissions, including the first password and the module ID#. For example, the length of time Tp for the auto-polling timer 216 can be long in a standby mode when a registered smart fob is not in proximity as opposed to an active mode when a registered smart fob is in proximity register.

As shown in FIG. 5, the module processor 217 is connected to module system memory 218. The module processor 217 receives the decryption algorithms and other program for operation of the smart module 210 from the module system memory 218. The fob registration numbers of all registered smart fobs and the fob ID#'s respectively associated with the fob registration numbers are also stored in the module system memory 218.

An I/O interface 220 is connected to the module processor 217 in FIG. 5. The I/O interface 220 provides the capability to make changes to the smart module 210. Amongst other uses, the I/O interface 220 can be used to update the registry of fob registration numbers and fob ID#'s in the module ID# and first password memory 219. In another example, the I/O interface 220 can be used to set the length of time Tp for the auto-polling timer 216 to be longer so as to conserve power usage.

As shown in FIG. 5, a high frequency antenna 223 is connected to a high frequency receiver 222 for receiving a high frequency HF wireless transmission, including a second password and a fob ID#. The module processor 217 is connected to the high frequency receiver 222 and receives the second password and the fob ID# from the high frequency receiver 222. If the second password and the fob ID# are from a smart fob registered to the smart module 210, a start pulse is sent to the resettable timer 224, which is connected to the module processor 217.

The resettable timer 224, shown in FIG. 5, enables an RF transmitter 225, which is connected to the resettable timer. The RF transmitter 225 transmits the third password PW3 provided by the module processor 217 through an RF antenna 226. The module processor 217 can also turn-on sound device 227 when the resettable timer 224 receives a start signal. When the resettable timer 224 enables the RF transmitter 225, the third password PW3 is repeatedly transmitted.

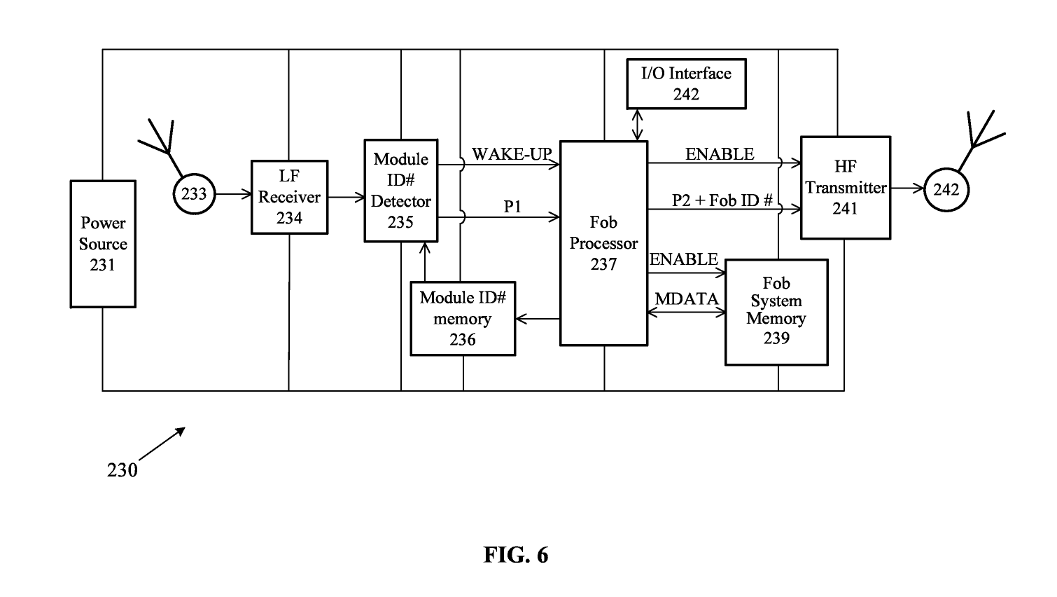

FIG. 6 is a block diagram of a smart fob according to an embodiment of the invention. As shown in FIG. 6, a smart module 230 includes a power source 231 that provides power to the components of the smart fob 230. The power source can be a battery or external DC power supply. In the case of an external DC power supply, a recharge circuit can be included that recharges the battery.

Amongst other components, the smart fob 230 in FIG. 6 includes a low frequency receiver 234 connected to a low frequency antenna 233 for receiving a module ID# and a first password. A module ID# detector 235 is connected to the low frequency receiver 233. A module ID# memory 236 is connected to the module ID# detector 235. The module ID# memory 236 contains the module ID# of smart modules to which the smart fob is registered. The module ID# detector 235 determines if the module ID# received by the low frequency receiver 233 is in the module ID# memory 236.

As shown in FIG. 6, the fob processor 237 is connected to the module ID# detector 235. The fob processor 237 is woke-up if the module ID# is from a smart module to which the smart fob 230 is registered. When the fob processor 237 is woke-up, the fob processor 237 can enable a high frequency transmitter 241 and a fob system memory 239, which are connected to the fob processor 237. The fob processor 237 receives the encryption algorithms and other programs for operation of the smart fob 230 from the fob system memory 239. The fob registration number and the fob ID# for the smart fob 230 are also stored in the fob system memory 239.

Upon the wake-up, the first password is sent by the module ID# detector 235 to the fob processor 237 to generate a second password based on the first password received and a fob registration number stored in the fob system memory 239. Then, the fob processor 237 can send the second password and the fob ID# to the high frequency transmitter 241 either automatically or, in the alternative, when a manual trigger 238, such as button, is activated. A high frequency antenna 242 is connected to the high frequency transmitter 241 for transmitting a high frequency HF wireless transmission, including the second password and the fob ID#.

An I/O interface 242 is connected to the fob processor 237 in FIG. 6. The I/O interface 242 provides the capability to make changes to the smart fob 230. Amongst other uses, the I/O interface 242 can be used to update the fob registration number and the fob ID# in the fob system memory 239. In another example, the I/O interface 242 can be used to update the smart module ID# to which the smart fob 230 is registered in the module ID# memory 236.

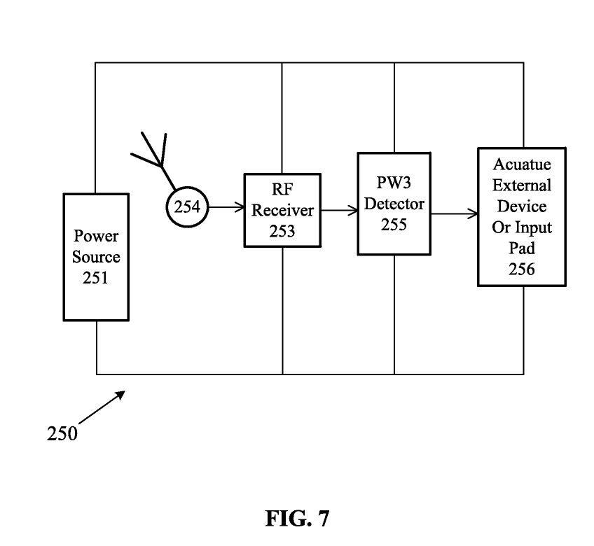

FIG. 7 is a block diagram of a receiving device according to an embodiment of the invention. As shown in FIG. 7, a receiving device 250 includes a power source 251 that provides power to the components of the receiving device 250. The power source 251 can be a battery, solar-assisted battery or external DC power supply.

Amongst other components, the receiving device 250 in FIG. 7 includes an RF receiver 253 connected to an antenna 254. A third password PW3 detector 255 is connected to the RF receiver 253 for determining whether the third password PW3 has been received by the RF receiver 253. Upon determination that the RF receiver 253 has received the third password PW3, actuating 256 either an external device or an input pad. For example, the actuating device 256 can be a relay to activate an electro-mechanical lock or a buffering device for turning on an electronic input pad, such as a key pad or finger pad.

It will be apparent to those skilled in the art that various modifications and variations can be made in the embodiments of the invention without departing from the spirit or scope of the invention. Thus, it is intended that embodiments of the invention cover the modifications and variations of this invention provided they come within the scope of the appended claims and their equivalents.

What is claimed is:

1. A smart module for actuating an electrical device in response to a smart fob, comprising:
a low frequency transmitter for transmitting a first password and a smart module ID number in a low frequency signal;
an auto-polling timer controlling a length of time between transmissions of the first password and the smart module ID number over a predetermined time frame;
a high frequency receiver for receiving a high frequency signal including a second password;
a memory for storing a registration number with which the smart fob is registered to the smart module, a smart module ID number for the smart module and a third password;
a sending unit for providing the third password to the electrical device; and
a processor for decrypting the second password and determining if the second password is from the smart fob registered to the smart module and then sending the third password to the electrical device via the sending unit if the second password is from the smart fob registered to the smart module.

2. The smart module for actuating an electrical device in response to a smart fob according to claim 7, wherein the processor is configured to enable the low frequency transmitter to transmit the first password and the smart module ID number of the smart module.

3. The smart module for actuating an electrical device in response to a smart fob according to claim 1, wherein the memory includes a first memory connected to the low frequency transmitter and the processor for storing the smart module ID number and the second memory connected to the processor for storing the registration number.

4. The smart module for actuating an electrical device in response to a smart fob according to claim 1, further comprising an indication device connected to the sending unit for an indication of the third password being sent to the electrical device.

5. The smart module for actuating an electrical device in response to a smart fob according to claim 1, further comprising an I/O interface connected to the processor for enabling registration of the smart fob by inputting the registration number into the memory.

6. The smart module for actuating an electrical device in response to a smart fob according to claim 1, further comprising a triggering device for initiating the auto-polling timer over the predetermined time frame.

7. The smart module for actuating an electrical device in response to a smart fob according to claim 6, wherein the triggering device is a motion sensor.

8. The smart module for actuating an electrical device in response to a smart fob according to claim 1, wherein the auto-polling timer is always on.

9. The smart module for actuating an electrical device in response to a smart fob according to claim 1, wherein the third password is sent in high frequency signal by a high frequency transmitter.

10. A system for actuating an electrical device, comprising:
a low frequency transmitter in a smart module for transmitting a first password and a smart module ID number in a low frequency signal;
a low frequency receiver in a smart fob for receiving the first password and the smart module ID number in the low frequency signal;
a first processor in the smart fob for providing a second password derived from the first password and a registration number with which the smart fob is registered to the smart module;
a high frequency transmitter in the smart fob for transmitting a high frequency signal including the second password;
a high frequency receiver in the smart module for receiving the high frequency signal including the second password;
a second processor in the smart module for decrypting the second password to determine if the second password is from the smart fob registered to the smart module and then enabling a third password to be sent to the electrical device if the second password is from the smart fob registered to the smart module.

11. The system for actuating an electrical device according to claim 10, further comprising a resettable timer in the smart module for running a predetermined period when the second processor enables the third password to be sent; and
a transmitter actuated by the resettable timer to send the third password to the electrical device while the resettable timer runs.

12. The system for actuating an electrical device according to claim 11, further comprising:
a polling timer controlling a length of time between transmissions of the first password and the smart module ID number over a predetermined time frame.

13. The system for actuating an electrical device according to claim 12, wherein the length of time between transmissions of a first password and a smart module ID number in a low frequency signal controlled by the polling timer is set to be less than the predetermined period of the resettable timer.

14. The system for actuating an electrical device according to claim 12, wherein the polling timer is always on.

15. The system for actuating an electrical device according to claim 10, further comprising a triggering device for initiating the polling timer for the predetermined time frame.

16. A system for actuating an electrical device according to claim 10, further comprising a memory in the smart module for storing a smart module ID number of the smart module to which the smart fob is registered and the registration number with which the smart fob is registered to the smart module.

18. A system for actuating an electrical device according to claim 16, further comprising an ID detector in the smart fob connected to the low frequency receiver for waking-up the smart fob if a smart module ID number in the low frequency signal matches a smart module ID number in memory.

19. A system for actuating an electrical device according to claim 10, further comprising a manual trigger in the smart fob for sending the second password.

20. A system for actuating an electrical device, comprising:
a low frequency transmitter in the smart module for transmitting a first password and a smart module ID number in a low frequency signal;
a low frequency receiver in the smart fob for receiving the first password and the smart module ID number in the low frequency signal;
a first processor in the smart fob for providing a second password derived from the first password and a registration number with which the smart fob is registered to the smart module;
a high frequency transmitter in the smart fob for transmitting a high frequency signal including the second password;
a high frequency receiver in the smart module for receiving the high frequency signal including the second password;
a second processor in the smart module for decrypting the second password to determine if the second password is from the smart fob registered to the smart module;
a radio transmitter for sending a third password to the electrical device if the second password is from the smart fob registered to the smart module.
